(19) United States
(12) Patent Application Publication
(10) Pub. No.: US 2004/0212495 A1
(43) Pub. Date: Oct. 28, 2004

(54) Portable emitter device for warning signals

(76) Inventor: Ming Der Chen, Taichung (TW)

Correspondence Address: Ming Der Chen, P.O. Box 63-99, Taichung, 406, TW

(21) Appl. No.: 10/424,213

(22) Filed: Apr. 23, 2003

(51) Int. Cl. G08B 1/08

(52) U.S. Cl. 340/539.11; 340/574

(57) ABSTRACT

An emitter device includes a watch-shaped emitter member having one or more switch buttons to be actuated to generate signals, and a control device having an antenna to receive signals from the emitter member. A wireless device and a CPU are coupled to the antenna to process the signals from the wireless device, and a communication device is coupled to the CPU, to send signals out to various service centers via various network systems. The emitter device may be easily carried with the users, and may be used to ask help from the service centers or the other people.

### BACKGROUND OF THE INVENTION

1. Field of the Invention

The present invention relates to an emitter device, and more particularly to a portable emitter device for generating warning signals and/or SOS signals to ask for help.

2. Description of the Prior Art

Typical personal digital assistant (PDA) devices have been developed to receive wireless signals from such as satellite facilities, and may be used to position the users by the satellite facilities. However, the PDA devices are expensive and comprise a large volume and a heavy weight that may not be easily carried with the users. In addition, the PDA devices may not be used to suitably receive the wireless signals from such as the satellite facilities when the PDA devices are moved into buildings or architectures.

For handicapped persons or old peoples, particularly the handicapped persons or the old peoples who live by themselves, it will be difficult for the handicapped persons or the old peoples, to ask for help with the PDA devices.

The applicant has developed a watch type signal emitter device which has been issued as U.S. Pat. No. 6,377,170 B1 to Chen, and which comprises a watch body for attaching onto the wrist portions of the users, and thus for allowing the typical signal emitter devices to be easily carried with the users and to emit warning signals. However, the typical signal emitter devices may not be used to connect to or to communicate with various network systems, in order to ask help from the others.

The present invention has arisen to mitigate and/or obviate the afore-described disadvantages of the conventional emitter devices.

### SUMMARY OF THE INVENTION

The primary objective of the present invention is to provide a portable emitter device for generating warning signals and/or for generating SOS signals to ask for help.

In accordance with one aspect of the invention, there is provided a n emitter device comprising an emitter member having at least one switch button to be actuated to generate signals, a control device including an antenna to receive the signals from the emitter member, a wireless device coupled to the antenna to receive and to process the signals from the antenna and the emitter member, a CPU coupled to the antenna to process the signals from the wireless device, a communication device coupled to the CPU, to send signals out to network systems, and a card member plugged to the communication device and to communicate with the network systems, and a recording device coupled to the CPU of the control device, to record information of users. The emitter member may be attached onto the users and may thus be easily actuated by the users. The control device may be shaped into the shapes or volumes of that of the typical portable phones or mobile phones, and may thus be easily carried with the users.

The control device includes means for energizing the CPU and the communication device and/or the wireless device. Various service centers may thus be easily communicated with the users via various network systems, in order to help the users when the users send out warning or SOS signals, or when the users have no response for a predetermined time interval.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram of a portable emitter device in accordance with the present invention; and

FIG. 2 is a perspective view illustrating the attachment of the portable emitter device onto the wrist portion of the users.

### DETAILED DESCRIPTION OF THE PREFERRED EMBODIMENT

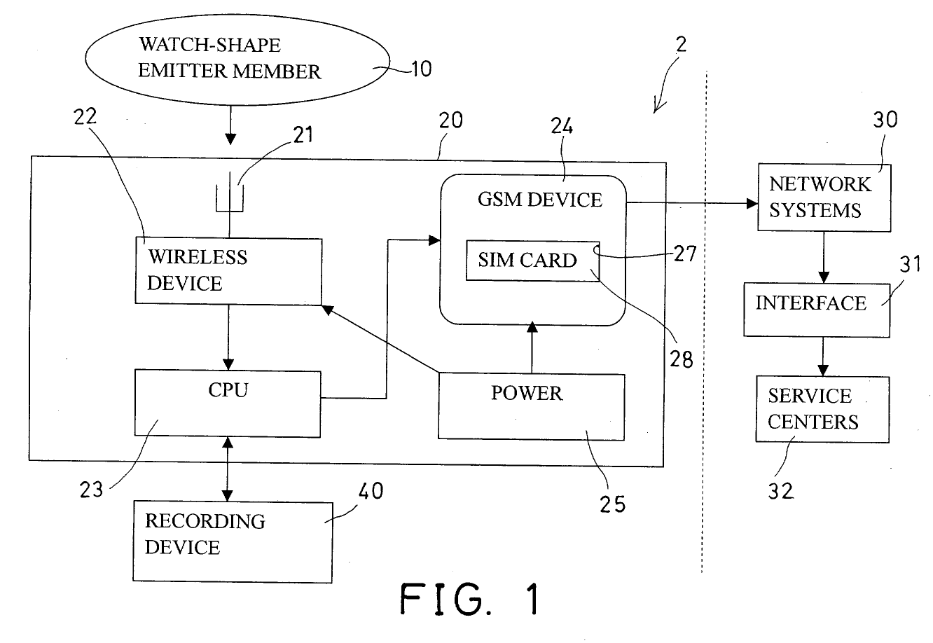

Referring to the drawings, and initially to FIG. 1, a portable emitter device in accordance with the present invention comprises a watch-shape emitter member 10 for attaching onto the users, such as the wrist portion of the users, and a control device 2 including a housing 20 which may be formed or shaped into that of the typical portable phones or mobile phones, and which may thus be easily carried with the users.

The control device 2 includes a central processing unit (CPU) 23 received in such as the housing 20, and an antenna 21 and a wireless device 22, such as a high frequency wireless sending and/or receiving module or device 22 coupled to the CPU 23, to send or emit or transmit signals out and to receive signals from the other facilities, such as various wireless network systems.

The wireless device 22 is provided to process or convert the signals, for allowing the signals to be communicated between the CPU 23 and the other facilities or the wireless network systems. The CPU 23 may be used to decode or to process the signals to and from the wireless device 22, and may include the typical memories for data and information storing purposes.

A transmitting or communication device 24, such as a global system for mobile communication (GSM) device 24 may also be received in such as the housing 20, and coupled to the CPU 23, for communicating with various wireless network systems 30, such as the local area network system, the wireless local area network system, the public telecommunication system, the blue tooth network system, etc.

For example, the communication device 24 may include a slot 27 formed therein to receive various card members 28, such as the subscriber identify module (SIM) card members, the universal serial bus card members, the blue tooth card members, etc., in order to emit or transmit warning signals or SOS signals to such as the police offices, the 119 service centers, the other service centers 32, etc., so as to ask help from the others.

The service centers 32 may be coupled to the various wireless network systems 30 via interface cards or devices 31, in order to send signals out and/or to receive signals from the users of the control device 2. For example, the service centers 32 may include computer facilities to monitor or to watch or to receive signals from the users of the control device 2 via the various wireless network systems 30, in order to help the users when required.

An electric power source or circuit or electric power supplier 25 may be provided and coupled to the CPU 23, the wireless device 22, and/or the GSM communication device 24, and/or the other electric parts or elements, in order to energize the electric parts or elements.

A recording device 40, such as a rewriteable or recordable recording device 40 may further be provided and coupled to the CPU 23, in order to record or store data or information of the users, such as the passwords, the identifications, the contact persons, the health conditions, etc., into the memories of the CPU 23 or of the control device 2.

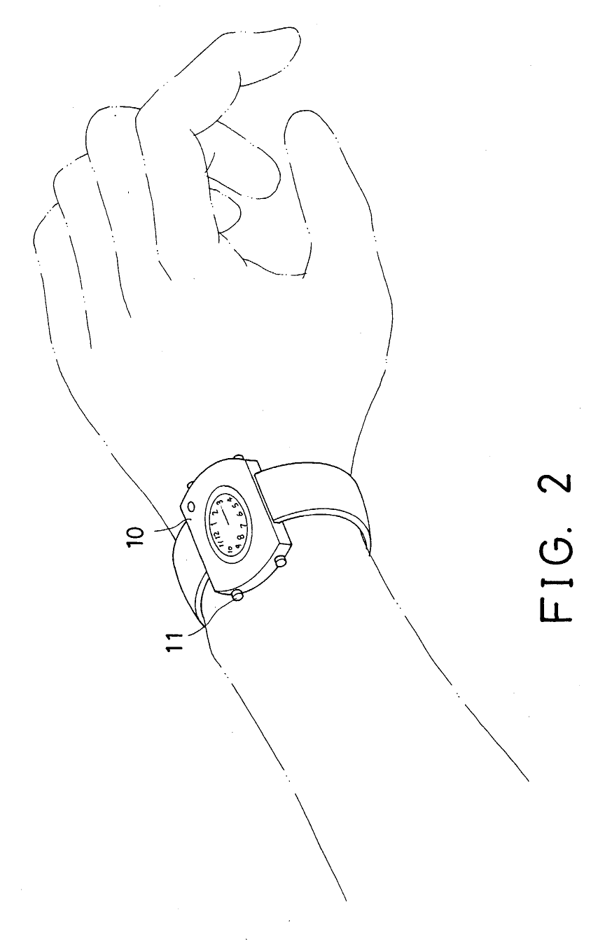

As shown in FIG. 2, the watch-shape emitter member 10 of the portable emitter device may be attached onto the users, such as the wrist portions of the users, and includes one or more switch buttons 11 for being depressed by the users, in order to emit or transmit warning signals or SOS signals to various service centers 32, so as to ask help from the others.

For example, when either of the switch buttons 11 of the emitter member 10 is depressed or actuated by the users, an initializing or actuating signal may be sent to the control device 2 which includes the antenna 21 and the wireless device 22 to receive the signals from the emitter member 10, and which includes the CPU 23 to process the signals, and which includes the GSM communication device 24 to communicate with various service centers 32 via the network systems 30.

One example of the emitting circuit of the emitter member 10 has been disclosed in the applicant's prior U.S. Pat. No. 6,377,170 B1 to Chen which may be taken as a reference for the present invention.

The portable emitter device is particularly designed for the handicapped persons or the old peoples who live by themselves, and who may most be required to ask for help from the others. When either of the switch buttons 11 of the emitter member 10 is depressed or actuated by the users, or when the emitter member 10 has not been actuated for a predetermined time interval, the people of the service centers 32 may easily and quickly locate the users, in order to help the users as early as possible.

In addition, when the users are rubbed or kidnapped by others, the users may also send out the SOS signals to the service centers 32, in order to ask help from the people of the service centers 32.

Accordingly, the portable emitter device in accordance with the present invention may be used for generating warning signals and/or for generating SOS signals to ask for help.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An emitter device comprising:
a) an emitter member having at least one switch button to be actuated to generate signals,
b) a control device including:
i) an antenna to receive the signals from said emitter member,
ii) a wireless device coupled to said antenna to receive and to process the signals from said antenna and said emitter member,
iii) a CPU coupled to said antenna to process the signals from said wireless device,
iv) a communication device coupled to said CPU, to send signals out to network systems, and
v) a card member plugged to said communication device and to communicate with the network systems, and
c) a recording device coupled to said CPU of said control device, to record information of users.

2. The emitter device as claimed in claim 1, wherein said control device includes means for energizing said CPU and said communication device.
